(19) United States
(12) Patent Application Publication
(10) Pub. No.: US 2004/0172563 A1
(43) Pub. Date: Sep. 2, 2004

(54) Method for protecting content stored on an information carrier

(76) Inventors: Robert Albertus Brondijk, Eindhoven (NL); Maurice Jerome Justin Jean-Baptiste Maes, Eindhoven (NL)

Correspondence Address: Corporate Patent Counsel, Philips Electronics North America Corporation, P O Box 3001, Briarcliff Manor, NY, 10510, US

(21) Appl. No.: 10/482,146

(22) PCT Filed: Jul. 3, 2002
(86) PCT No.: PCT/IB02/02754

(30) Foreign Application Priority Data
Jul. 6, 2001 (GB) 0116496.1
Jan. 24, 2002 (EP) 02075293.7

(51) Int. Cl. H04L 9/32

(52) U.S. Cl. 713/202

(57) ABSTRACT

The invention relates to a method for protecting content stored on an information carrier. In order to avoid that a user illegally circumvents a copy protection mechanism such as a watermark protecting said content to get an illegal access to said content, a method comprising the following steps is proposed:—reading a unique identifier present on said information carrier,—storing in a first memory information relating to illegal access actions on said information carrier using said identifier,—refusing access to said information carrier after a predetermined number of illegal access actions.

The invention relates to a method and corresponding apparatuses for protecting content stored on an information carrier, to a computer program for performing the method and to an information carrier storing the computer program.

Nowadays, “embedded data” (also called “digital watermarking”) is a technique used to embed copy control information in copyrighted material, such as music, movies and all kinds of audiovisual works. Watermarks may, for instance, be embedded in an audio or a video stream.

These watermarks may represent information indicating that the content, in which it is embedded, is e.g. never to be copied onto removable, optical media, or, indicating that the content should not be present on removable, optical media in unencrypted form. By way of example, a “Never Copy” video watermark, in unencrypted content on a recordable DVD disc, might be illegal, and might trigger a refusal to play back such content by compliant players. Another example is an audio watermark, indicating that content should only be recorded in encrypted form, which can be used to prevent the recording of audio content on a CD-RW, rewritable DVD or any other kind of optical disc.

Digital watermarking techniques typically require a significant amount of data to be examined before a reliable detection is possible. It may happen that several seconds of audio or video material, or derived data thereof, are being “accumulated”, and that the detection is then performed on the accumulated data.

One way of embedding data in a copyrighted material is disclosed in International Application WO 99/45705, which document is hereby enclosed by reference. As the person skilled in the art is familiar with existing techniques for embedding data (or watermarking) and as the invention is not related to techniques for embedding data, no further information is given.

In the practical implementation of play control and record control rules in a PC environment, the inventors have identified several problems related to the specific operations of a PC drive, and to the fact that the user can control the operations of the drive.

A first problem identified by the inventors is that a user can try to circumvent play control, by sending multiple “read” commands to a drive, until the watermark (WM) is found. When the watermark is found and the “reading” is interrupted, the user can simply initiate new “read” commands from the same disc. Since watermark detection often requires a significant amount (seconds) of data to be read, such an attack may be feasible. Similarly, for record control, “write” commands can be sent until the watermark is detected, but after the interruption, the process is simply continued.

A second problem identified by the inventors is that drives need not “read” or “write” audiovisual information sequentially, but the drive can process random portions from an audiovisual work in random order.

A third problem identified by the inventors is that it is possible to read or write protected data, using alternation of “read” and “write” actions of short pieces of content which are too small to allow for watermarks to be detected. In a straightforward implementation, a drive would then need two watermark detectors, which is expensive, or it would reset after each read or write action, thus enabling the described hack.

The invention has for an object to overcome the problems identified by the inventors, particularly the first problem, so as to avoid that a user illegally circumvents a copy protection mechanism such as a watermark protecting said content and gets an illegal access to said content.

This object is achieved according to the present invention by a method as claimed in claim 1, comprising the steps of:

reading a unique identifier present on said information carrier,

storing in a first memory information relating to illegal access actions on said information carrier using said identifier,

refusing access to said information carrier after a predetermined number of illegal access actions.

The invention is based on the idea that for preventing circumvention by multiple “read” or by multiple “write” actions the fact can be exploited that information carriers, such as recordable discs, have unique numbers (e.g. CD-R, DVD-RAM, DVD-RW, DVD+RW) which can easily be used as unique identifiers. Each time, an illegal read or write action is encountered, this is stored in said first memory, preferably located within the PC drive. After N illegal actions (N>1), the drive may refuse to read data from said information carrier and/or to write data to said information carrier.

In this way the above described first problem can be prevented, i.e. repeatedly sending read or write commands after an error condition has been detected will be observed. It will only be possible to repeat these commands for a limited number of times so that only a limited amount of data can be illegally retrieved.

Preferred embodiments of the invention are defined in the dependent claims.

According to a first preferred embodiment a second memory storing identifiers of information carriers on which illegal access actions appeared is used to check if the identifier of the present information carrier is stored therein. In this case the number of illegal access actions appeared on said information carrier, which number is stored in said first memory, is increased. In case said identifier is not yet stored in said second memory an entry is made in said second memory and the number of illegal access actions on said information carrier will now continuously be registered in the first memory. Thus, for each individual information carrier a separate register is held in the second memory storing the number of illegal actions appeared on said information carrier allowing a check whether said individual information carrier shall be made accessible to the user or not.

According to another preferred embodiment copy protection data which are embedded in the content stored on the information carrier are read and used to control the access to the content. Particularly, watermark data are used as copy protection data which may be used by a watermark detector to check if an error-condition, i.e. an illegal access action, appears or not. Said copy protection data may comprise the information if and how often a content stored on the information carrier may be copied or read or if it is allowed to write to the information carrier. In general, any particular access to the content can be controlled via said copy protection data.

The proposed solution can be used in, but is not limited to, all PC drives which can read data from or write data to information carriers, particularly recordable or rewritable optical record carriers, such as CD, DVD or DVR information carriers. Such optical record carriers usually carry a unique number which can easily be used as identifier in the above-described sense.

In case the access to the information carrier is refused after a predetermined number of illegal access actions it will preferably be only allowed to reformat the information carrier so that any content stored thereon which might have been retrieved by illegal actions will be deleted. The information carrier, in particular the identifier thereof, will then also be cancelled from said second memory. Alternatively, as a less strong measure in case of refusing access to the information carrier it could be foreseen that the information carrier is simply not accepted but automatically outputted from the reading device. In this case, however, the identifier of said information carrier would not be cleared from the second memory.

The invention relates also to an apparatus for protecting content stored on an information carrier as claimed in claim 7 comprising a reading unit, a first memory and an access control unit. Further, the invention relates to a personal computer comprising a drive as claimed in claim 8, a computer program as claimed in claim 9 and an information carrier as claimed in claim 10 storing a computer program as claimed in claim 9.

The invention will now be explained in more detail with reference to the drawings, in which:

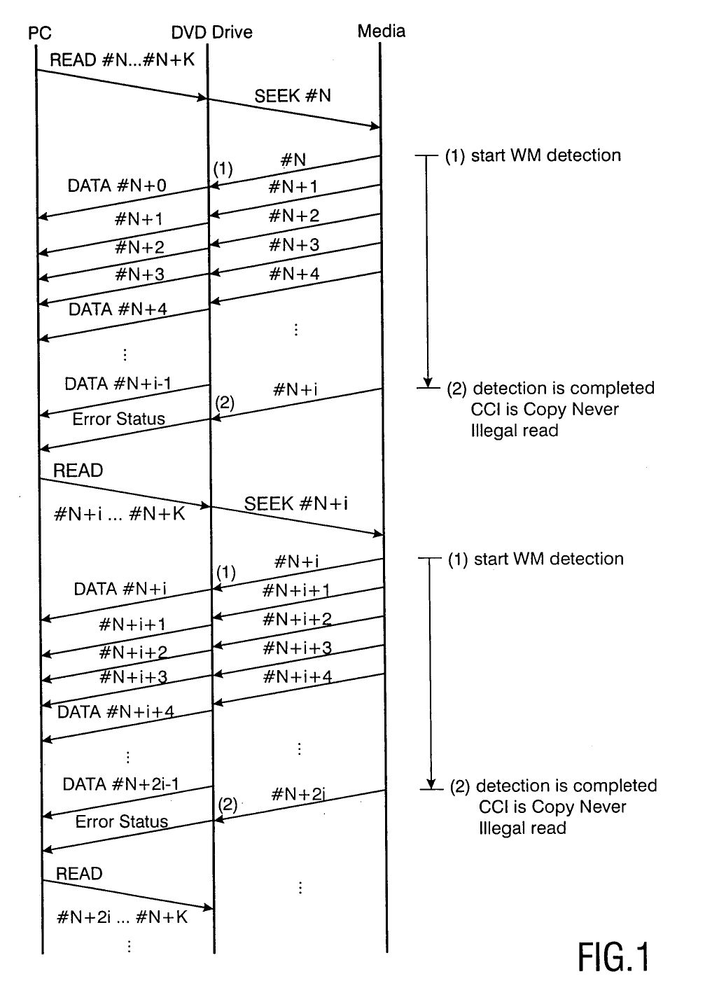

FIG. 1 illustrates the problem of repeated read actions after error-detection,

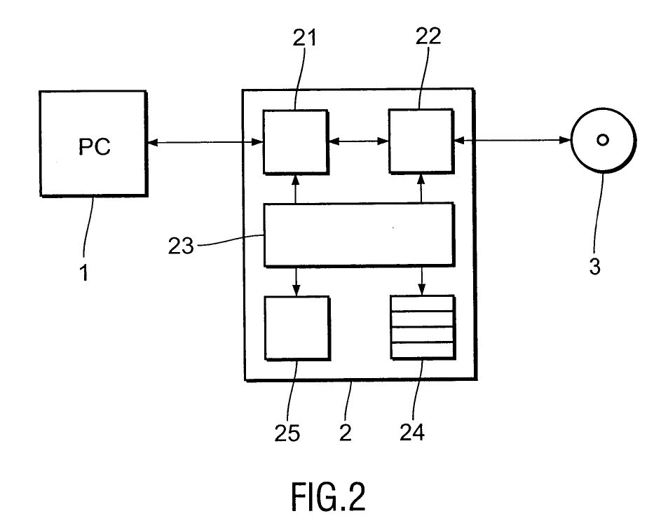

FIG. 2 shows an apparatus according to the invention and

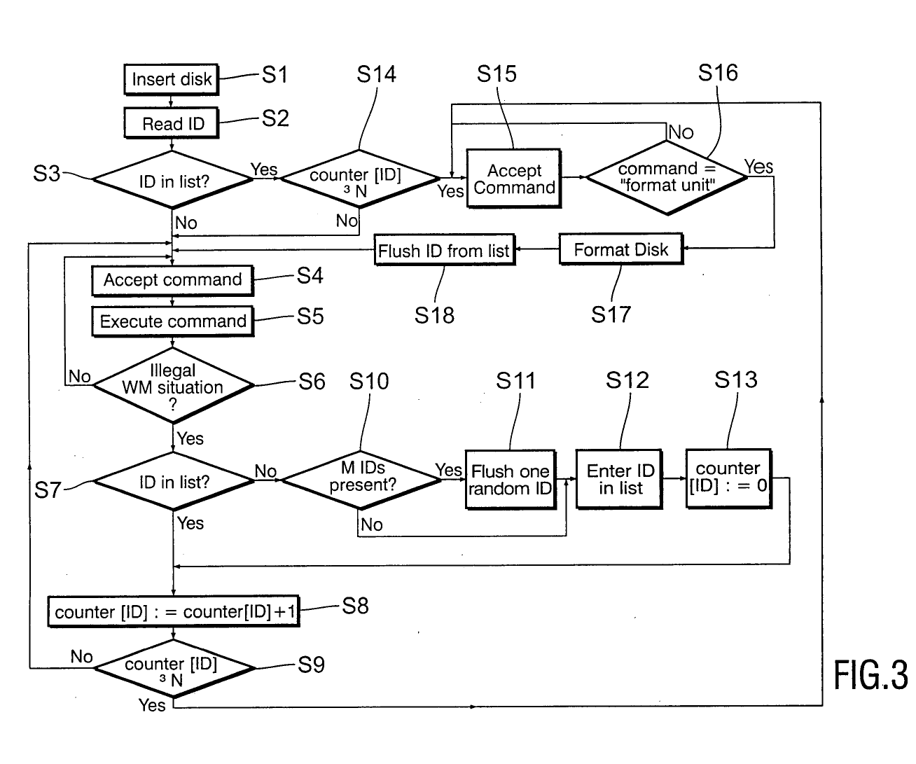

FIG. 3 shows a flow chart illustrating the method according to the invention.

By way of an example, the following preferred embodiment of a video watermark in the DVD “Copy Never” context is described.

In general, a DVD PC drive only understands “read command+data” and “write command+data”. The data is always transmitted in units of 2 KB (this is called a sector), in a maximum burst of 32 sectors (under Windows and most other operating systems). This implies that a drive has no notion of large contiguous sequences like a video recorder. For this reason, the watermark guidelines have to be tailored to speak in terms of “sectors”, “read! and “write”.

FIG. 1 illustrates the problem to be solved by the present invention. Shown are the actions along a time scale (from top to bottom) performed by a PC and a DVD drive to read data from the disc (“media”). It is assumed that a hacker attempts to read illegal copy-never content stored on a recordable disc in K sectors starting at sector #N. After i sectors, a watermark detector finds a watermark causing a check condition (CCI; also called error message or sense code) which tells the PC that a water mark was found in data that is not allowed to be read from or written to that disc. Consequently the transfer of the data is stopped. Thereafter the hacker may try to read sectors #N+i to #N+K Again, after i sectors a watermark will be detected and another error message will be sent to the PC. This may be continuously repeated, i.e. the hacker-software now keeps activity issuing multiple read requests to the DVD drive. In this way, slowly the hacker retrieves all data from the disc in small blocks of e.g. approximately 1 sec., since the watermark detection algorithm takes some time to execute, in practice at least 1 sec., during which activity the drive delivers illegal data to the PC.

FIG. 2 shows an apparatus for protecting contents stored on an information carrier according to the present invention. As in FIG. 1a PC 1 is used to access an information carrier, in this case a disc 3, via a drive 2 including the apparatus for protecting the content stored on the disc 3. It should be noted that the drive 2 can be a separate device as shown in FIG. 2, but can also be integrated into the PC 1, such as a PC disc drive.

The drive 2 comprises, among other known elements which are not relevant to the present invention and are thus not shown, an interface 21 to the PC 1, e.g. an ATAPI interface, and an access unit 22 for accessing the disc 3, e.g. for reading data from or writing data to the disc 3. The interface 21 and the access unit 22 are controlled by an access control unit 23 for controlling access of the PC 1 to the disc 3 which is adapted to refuse access in case of illegal access actions. Said access control is based on information stored in a first memory 24 and a second memory 25.

In the second memory 25 the unique identifiers of information carriers are stored on which illegal access actions appeared in the past. Since optical discs each carry a unique number which can be used as identifier the second memory 25 stores a number M of such numbers of discs on which an error condition such as an “illegal watermark” sense code was registered.

In the first memory 24 which is divided into a number of memory units each unit being assigned to one of the identifiers stored in the second memory 25 the number of illegal access actions appeared on each particular disc registered in the second memory 25 is stored. Such numbers are checked by access control unit 23 against a predetermined number of allowed illegal actions.

The present invention shall now be explained in more detail with reference to FIG. 3 showing a flow chart of the method according to the invention. After inserting the disc (step S1) and reading the identifier ID (S2), i.e. the unique number, it is at first checked (S3) if the identifier is in the list stored in the second memory 25. If this is not the case the requested access, e.g. a read or write command is accepted (S4) and executed (S5). If during execution no illegal watermark situation appears (S6) the acception and execution of further commands is continued until no further command is received.

If an illegal water mark situation appears in step S6 it is subsequently checked (S7) if the identifier is stored in the second memory 25. In the positive case the corresponding entry in the first memory 24, i.e. the counter[ID] is incremented by one (S8). If said number of illegal access actions, i.e. said counter, does not exceed a predetermined number N of allowed illegal actions (S9) further commands will be accepted and executed (S4, S5) while otherwise access to the disc is denied.

If in step S7 after detection of an illegal watermark situation it is found that the identifier of said particular disc is not yet stored in the second memory 25 the identifier ID will be stored therein (S12) after it has been checked if already an upper limit number M of identifiers is present in the second memory 25 (S10) in which case one identifier would be cancelled from the list (S11), e.g. a random entry or the oldest entry in the list would be flushed (S11) and replaced by the present identifier (S12). In addition, the corresponding counter of illegal actions for said identifier is set to zero (S13). Processing will then be continued with step S8.

In case that already at the beginning in step S3 the identifier of the information carrier that shall be accessed is found in the second memory 25 it is already at this point checked if the number of illegal actions for said particular identifier exceeds the predetermined allowed number N (S14). If this check is negative, the requested command will be accepted and executed (S4, S5) while in the positive case only the command “format unit” will be accepted (S15, S16), i.e. the requested access to the disc is denied, the disc is formatted (S17) and the corresponding counter for said particular identifier is flushed from the second memory 25. Thereafter further commands will be accepted and executed (S4, S5).

It should be noted that the predetermined number N of allowed legal actions should be small enough so that the amount of data that can be (illegally) copied should not exceed a few minutes. However, said number N should be large enough to overcome delays in the data processing path, in particular in the path between GUI, OS and the drive. The user should also be given a chance to “repent” his illegal actions and to delete the illegally retrieved data.

According to this preferred embodiment, the following watermark detection strategy is used. The data drive is to “accumulate” all of the sectors containing DVD video it encounters, independent on whether the sector was transferred in a read or in a write action. The accumulation continues until there is sufficient material for a watermark detection to be performed. This accumulation phase is followed by an analysis phase. If the analysis results in a positive recognition of a watermark, then the drive must feedback this, in some manner, to the user. If the disc is a recordable disc, the drive will then remember its unique disc ID. The unique disc ID will be coupled, in the drives' flash memory, with a number “1”, which is the number of times a watermark has been found on that disc. If that number exceeds a number “N”, all read and write actions will be blocked of that disc for a period of time. What that period of time is, may be influenced by a number of factors: the number of discs a drive can remember or the last time the drive was completely flashed. In any case, the number “N” (a practical value may be 10) is too small for a user to clandestinely copy a movie of several minutes, yet it is large enough for the user to either delete all of his illegal material or copy his legal material from the disc. The only way a user can make a disc, for which n>=N, usable again is to let the drive successfully execute a “format unit” command. After reformatting the disc, the drive must then delete that disc ID from its list of illegal discs. In this way, a user is able to reinstate a previously illegal disc.

The way drives can feedback to the user that a WM has been found could be by the drive giving a “check condition” and placing a new sense code in the sense buffer which tells the user that a “WM Copy Never has been detected”. There after, the drive may choose to e.g. perform a “tray-out” or a pause so that the user clearly realizes that something is wrong and that his transfer action is clearly interrupted.

This preferred embodiment can be summarized as follows:

(Accumulation Phase:)

the drive accumulates sectors of video information, regardless of the order in which they are read or write,

the drive accumulates sectors of all transferred data, hence for both read as write,

the drives accumulates until it has sufficient material for the analysis phase

(Analysis Phase:)

if a “Never Copy” WM is detected, then the drive shall look if the disc ID is present in the memory, otherwise it will create an entry, in which case “n”=0,

the corresponding “n” will be incremented,

the PC drive may choose to perform a “tray-out” (i.e. the removing of the disc from the drive) or a pause,

if “n”>=N”, then no read or write actions will be allowed, only the SCSI command “FORMAT UNIT” and the drive will send a “check condition” to the host and place a “Never Copy WM” in the sense buffer (the “sense buffer” is the information which a drive will send to the host in response to the SCSI command “REQUEST SENSE”).

After a disc has been inserted, the drive will look at its disc ID and check if it appears in its database present in the memory. If that disc is already in the database and “n”>=“N”, the actions as above will be taken.

1. A method for protecting content stored on an information carrier, the method comprising the steps of:
reading a unique identifier present on said information carrier,
storing in a first memory information relating to illegal access actions on said information carrier using said identifier,
refusing access to said information carrier after a predetermined number of illegal access actions.

2. The method according to claim 1, further comprising the steps of:
checking if said identifier is stored in a second memory storing identifiers of information carriers on which illegal access actions appeared, and
storing said identifier in said second memory if an illegal access action appears if said identifier is not yet stored in said second memory or increasing the number of illegal access actions appeared on said information carrier which is stored in said first memory.

3. The method according to claim 1, further comprising the steps of:
reading copy protection data, in particular watermark data, embedded in said content stored on said information carrier,
controlling access to the content based on the read copy protection data.

4. The method according to claim 1,
wherein said information carrier is an optical record carrier, in particular a recordable or rewritable optical record carrier, and
wherein said identifier comprises a unique number stored on the optical record carrier.

5. The method according to claim 2, further comprising the steps of:
formatting the information carrier in case of refusing access to said information carrier after a predetermined number of illegal access actions, and
canceling the identifier of said information carrier from said second memory.

6. The method according to claim 2,
wherein said first and said second memory are part of a PC drive used for accessing said information carrier.

7. An apparatus for protecting content stored on an information carrier comprising:
a reading unit for reading a unique identifier present on said information carrier,
a first memory for storing information relating to illegal access actions on said information carrier using said identifier,
an access control unit for refusing access to said information carrier after a predetermined number of illegal access actions.

8. A personal computer comprising a drive for accessing an information carrier, said drive comprising an apparatus for protecting content stored on said information carrier according to claim 7.

9. Computer program comprising program code means for performing the steps of anyone of the methods as claimed in claims 1 to 6.

10. Information carrier storing a computer program as claimed in claim 9.
